(19) United States
(12) Patent Application Publication
(10) Pub. No.: US 2005/0131207 A1
(43) Pub. Date: Jun. 16, 2005

(54) Method for the production of epoxidized polysulfides

(76) Inventors: Michael Zeitler, Alfter (DE); Nils Kottner, Greiz (DE); Manfred Bergfeld, Erlenbach-Mechenhard (DE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/507,418

(22) PCT Filed: Mar. 8, 2003
(86) PCT No.: PCT/EP03/02388

(30) Foreign Application Priority Data
Mar. 14, 2002 (DE) 102 11 295.9

(51) Int. Cl. C08F 8/08

(52) U.S. Cl. 528/494

(57) ABSTRACT

Disclosed is a method for producing polymeric polysulfides containing terminal epoxy groups, according to which polysulfides containing terminal thiol groups are reacted with an excess of epichlorohydrin and alkaline lye, water is azeotropically distilled away with epichlorohydrin, the epichlorohydrin-containing epoxidized polysulfide solution is separated from the eliminated salt, the epichlorohydrin is distilled away, and the residue is optionally purified by means of thin film distillation. The reaction product is particularly suitable for the production of high-quality sealants, adhesives, and coatings. Said product has a high degree of purity and an extremely low chlorine content. The inventive method does not require any additional organic solvents and is very environmentally friendly.

The invention relates to a method for producing epoxidised polysulphides. Epoxidised polysulphides and methods for producing them have been known for some time. Thus, in U.S. Pat. No. 2,731,437 corresponding epoxidised polysulphides and means for preparing them are described. In the method disclosed therein, a polysulphide containing thiol terminal-groups and having very high molecular weights is first manufactured from an organic di-halogenide and an inorganic polysulphide.

In this way, for example, a dithiol of the formula
HS(CH₂CH₂OCH₂OCH₂CH₂SS)ₙCH₂CH₂OCH₂OCH₂CH₂SH,
is produced from sodium polysulphide and dichloroethylformal (Cl CH₂ CH₂ OCH₂ OCH₂ CH₂ Cl).
where n=25 to 250 or higher

This mixture of substances which is difficult to process is then subjected to a reductive —S—S-splitting to attain defined molecular weights which are appropriate for the further processing to yield the epoxidised product. When dichloroethylformal is used, the SH-terminalised polysulphides have a mean molecular weight of about 168 to 4,000 and have a viscosity of about 0.5 to 400 Poise at room temperature.

These compounds which may also be described as aliphatic saturated oxahydrocarbopolythio—polymercaptans are the actual starting materials for the manufacture of the epoxidised polysulphides claimed in U.S. Pat. No. 2,731,437.

The synthesis of the epoxy-modified polysulphides takes place in two stages, whereby firstly the polymeric dithiol reacts with epichlohydrin accompanied by ring opening in accordance with the following equation, 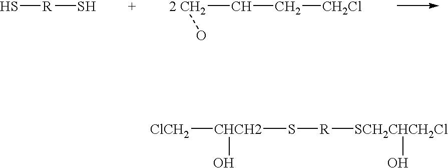
where the added alkali hydroxide serves as a catalyst.

In the second stage, new ring closure occurs accompanied by alkali chloride being split off, whereby alkali hydroxide is consumed stoichiometrically in accordance with the following equation 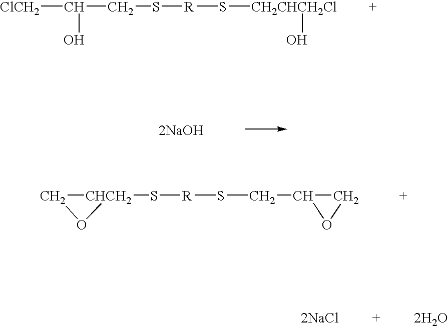
R=—(CH₂CH₂—O CH₂ O CH₂ CH₂SS)ₙ CH₂ CH₂ OCH₂ OCH₂ CH₂— and n=a whole number between 1 and 50.

Since the reaction is strongly exothermic this should be carried out in the presence of a diluent such as alcohol or ether in accordance with the teaching of U.S. Pat. No. 2,731,437.

The processing of the reaction product then takes place as follows: the organic solvent (diluent) that was used for the reaction is distilled off together with any epichlorohydrin that may still be present. The residue is then taken up with another solvent that is not miscible with water.

This organic solution is then washed with water (extracted) in order to remove any remaining (unused) alkali and, in particular, the inorganic salts.

The solvent in this organic solution which has been freed from inorganic constituents is then removed by distillation leaving behind the desired end-product, an epoxidised polysulphide—which if epichlorohydrin is used is a glycidylthioether of the polythiol used.

The method described in this U.S. patent suffers from a whole series of severe disadvantages. For one thing, two different solvents are used which need to be distilled off and given further treatment—this is labour intensive and calls for additional energy and the provision of additional supply tanks, pumps, etc. Working with and processing different organic solvents is also, environmentally unfriendly.

Furthermore this method of preparation produces an aqueous salt solution which, in addition, is contaminated with an organic solvent. This also requires a considerable effort to deal with and is accompanied by very substantial environmental problems. Finally, the end-products still contain a considerable amount of chlorine compounds so that the end-product cannot be described as particularly pure.

A similar method is described in U.S. Pat. No. 173,549 and corresponding EP 0 347 131 B1 , in which the reaction between the polysulphide with mercapto-terminal groups and epichlorohydrin is carried out in the absence of such solvents which, under the synthesis conditions, can form a mono-phase azeotropic mixture with the epichlorohydrin or with epichlorohydrin and water.

Instead of this, epichlorohydrin is used in excess (3.5 to 4 equivalents) with respect to the polysulphide and the reaction of the mercaptan with the epichlorohydrin is started by dripping in the alkali hydroxide at temperatures of about 60° C. Similarly, the ring closure to form the epoxide accompanied by alkali chloride being split off also takes place at this temperature.

During the course of the reaction, water or an azeotrope of water and epichlorohydrin is distilled off At the end of the reaction the remainder of the epichlorohydrin is distilled off and the residue needs to be taken up in a processing solvent, e.g. toluol, in which the inorganic constituents are not soluble. Only then does separation take place by filtration.

Although a whole series of procedures for the production of epoxidised polysulphides is known already, there remains a great need for an improved production process which, in particular, takes account of the more demanding ecological standards.

The object of the invention is to provide a method for the manufacture of epoxidised polysulphides in which the polysulphides exhibiting mercapto terminal-groups, epichlorhydrin and alkali are reacted together, which permits a more simple and economic handling technique, involves fewer handling stages than the methods representing the state of the technology—and, which at the same time is both more environmentally friendly and results in epoxidised polysulphide which has a very high degree of purity.

This object is achieved by a method for the manufacture of polymeric sulphides having epoxy terminal-groups in which polysulphides having thiol terminal-groups are dissolved in an excess of epichlorohydrin after which the reaction is started by the addition of alkaline lye, this being followed by a second stage in which further alkaline lye is added whereby the water and epichlorohydrin present in the reaction mixture are distilled off azeotropically, the essentially water-free organic phase is separated from the deposited salts and the epichlorohydrin is removed by distillation from the separated organic phase, whereby the residue consists of polymeric polysulphide having epoxy terminal-groups; this latter may be still further purified by distillation.

Expediently, the temperature during the first stage is kept below 70° C. by cooling, the range between 20 and 50° C. being particularly advantageous. In the second stage, the temperature may be advantageously kept between 40 and 90° C. by heating.

Preferably, caustic soda solution and, in particular, an aqueous 5-50 % by weight solution of caustic soda is used as the alkaline lye. Preferably, the alkaline lye is used in stoichiometric quantities or in excess up to double the stoichiometric quantity. It is advantageous to add catalytic quantities in the first stage or up to about 20% of the total amount used.

It is advantageous if a 2- to 12-fold excess of epichlorohydrin is used, preferably a 3- to 10-fold excess and, in particular, a 4- to 8-fold excess.

Preferably, the reaction takes place in the presence of a phase-transfer catalyst; in this context may be mentioned quaternary ammonium salts and, in particular, methyltrioctylammoniumchloride (obtainable under the trade name of Aliquat 336).

In a particularly advantageous embodiment of the method according to the invention the purification by distillation of the polysulphide exhibiting epoxy terminal-groups is carried out using thin-film distillation.

In a further embodiment of the method according to the invention the thin-film distillation is carried out in the presence of an agent which forms an azeotrope with epichlorohydrin. For this purpose, n- or iso-propanol are particularly suitable.

A further advantageous embodiment of the method according to the invention consists of arranging that after the azeotropic distillation of the water present in the reaction mixture, the deposited alkali chloride is filtered off in a sealed filter (Rosenmund filter) and then washed with epichlorohydrin.

Any epichlorohydrin adhering to the alkali chloride is dried off by means of a hot inert gas. The manufacture of the epoxy-terminalised polymeric polysulphide can be effected, for example, as described below:

Firstly, an excess of epichlorohydrin—expediently a 2- to 10-fold molar excess with respect to the polymer being used—is added and mixed with the polysulphide that is to be epoxidised. Commercially available products such as Thioplast or Thiokol made by the Akcros company or Rohm & Haas may be used.

A quaternary ammonium salt may also be added to the mixture as a phase transfer catalyst after which the desired quantity of sodium lye may be added continuously at normal pressure.

In general, the first stage of the reaction in which the epichlorohydrin is added to the mercaptan and ring opening takes place lasts for about 30 minutes. Since the reaction is strongly exothermic, cooling is applied in order to keep the temperature between 20 and 50° C. Dosing with sodium lye is then continued and the temperature adjusted to between 40 and 90° C.

The precise temperature that is required depends upon the pressure that is selected. The conditions must be so selected that water and epichlorohydrin are distilled over as an azeotrope. Preferably, a vacuum of about 50 to 70 millibars is applied. The reaction has come to an end when no further azeotrope is distilled over.

The solution of epoxidised polysulphide in epichlorohydrin is then cooled to about room temperature. The sodium chloride which is produced crystallises out and can be separated from the organic solution without any difficulty.

This can be effected, for example, by filtering off the separated salt from the solution.

It is, however, also possible to separate the salt from the organic solution by simple decantation or by lifting out the eliminated salt. This, in particular, is advantageous because the salt often adheres to the edges and base of the reaction vessel.

The filtered off solution which contains the epoxidised polysulphide and epichlorohydrin is then freed from epichlorohydrin by distillation. Depending upon the ultimate application, the residual reaction product can then be submitted to a thin-film distillation. This thin-film distillation frees the epoxidised polysulphide from traces (<100 ppm) of epichlorohydrin. The separation of the epichlorohydrin can be improved still further if an organic fluid which forms an azeotrope with epichlorohydrin is added. Quite small amounts are sufficient, e.g. 1 to 10%. In particular, n- or iso-propanol is suitable for this purpose.

The product thus obtained has a very high level of purity and an extremely low content of epichlorohydrin, inorganic salts and chloro-compounds.

While the chlorine content obtained using the method described in U.S. Pat. No. 2,731,437 can amount up to 0.62% the chlorine content obtained with the method according to the invention is lower by several powers of ten. The product obtained can be further processed as it is. It is particularly surprising that the inorganic salts are quantitatively removed from the product without any need for washing out with water.

The method in accordance with the invention clearly leads to complete insolubility of these salts in the organic phase.

It was particularly surprising that by using the method in accordance with the invention it is possible to manufacture epoxy-terminalised polymeric polysulphides having a high degree of purity in a simple and economic manner which are capable of being used for the most diverse applications.

The method operates in a manner which is considerably more environmentally friendly since apart from epichlorohydrin no other organic solvents are used throughout the course of the reaction which, in other more complicated processing operations, would need to be purified after use.

The sodium chloride which is produced during the reaction crystallises out and can be disposed of either directly or taken up in water.

The mixture of water and epichlorohydrin which is produced by the azeotropic distillation is also easy to deal with since after the distillation the azeotrope again separates into two phases, whereby the organic (lower) phase can be used directly in the reaction once more. Since no other solvent such as alcohol or ether is used in the reaction and no solvent such as toluol is used to dissolve the separated epoxidised polymer the method operates in a very environmentally-friendly manner and saves considerable amounts of energy.

Since the quality of the product is outstanding, it is also very suitable for further processing, e.g. for the manufacture of adhesives, coatings, sealing compounds, etc..

The invention is described in more detail by the following examples.

### EXAMPLE 1

200 kg of epichlorohydrin are placed in a 500-litre double-jacketed glass reactor (Schott Co., Mainz) equipped with an anchor stirrer, a distillation set, a phase separator, and a base discharge valve. Into this is dissolved with stirring 220 kg of a polymeric polysulphide having thiol terminal-groups and a mean molecular weight of about 1100 (Thioplast G4 made by the Akcros Chemical Company, D 07973, Greiz). Once a clear solution has been produced, 400 g of Aliquat 336 are added.

The reactor is cooled with spring water and, altogether, 40 kg of 50% sodium lye are metered in. The addition is effected in such a manner that the temperature in the reactor does not exceed 50° C. After about 30 minutes during which about 6 kg of aqueous sodium lye is metered in, the cooling is stopped and the reactor is heated with low-pressure steam to 50° C.

Now a vacuum of 50 mbar is applied and the remaining amount of aqueous sodium lye is metered in over a period of about an hour. During this time an azeotropic mixture of water and epichlorohydrin distills through the distillation unit and this is separated in a phase separator into an upper aqueous phase and a lower epichlorohydrin phase. The lower phase is continuously fed back into the reactor. To complete the reaction, the temperature is raised to 70° C. and the vacuum adjusted to about 100 mbar, and under these conditions, the remaining water is removed over 2 hours by means of azeotropic distillation.

Then the return of the epichlorohydrin phase from the phase separator is stopped and the remaining water removed by distillation. This takes about half an hour. The end of the water-removal activity can be recognised by the fact that the temperature in the distillation unit rises to the boiling point of pure epichlorohydrin. To complete the crystallisation of the sodium chloride and the excess NaOH the contents of the reactor are cooled to 20° C. The stirrer is switched off and, after 12 hours, the solution is removed from the separated crystals by decantation. The solution containing the reaction product is then substantially freed from epichlorohydriri by being distilled at a pressure of 25 mbar and at a temperature of 30-80° C. for 2 hours.

In order to remove the remaining traces of epichlorohydrin the slightly viscous polymer is purified by using a two-stage thin-layer evaporator made by the Fischer Company of Meckenheim which has a total surface area of 0.45 m² at a pressure of 0.1-2 mbar. The yield relative to the thioplast used is 98.5%; the product is obtained as a clear, bright-yellow low-level viscous (2 Pas) fluid with a residual epichlorohydrin content of less than 100 ppm.

### EXAMPLE 2

Following the same method as used in Example 1, 165 kg of thioplast G4 is dissolved in 120 kg of epichlorohydrin and to this is added 150 kg of 10% aqueous sodium lye as described in Example 1 but without the addition of a phase transfer catalyst. After about 20 minutes, during which 23 kg of the 10% aqueous sodium lye is metered in, the cooling is turned off and the reactor is heated to 70° C. A vacuum of 100 mbar is applied and the remaining quantity of sodium lye is metered in over a period of 2 hours. The distillation of the azeotrope, the separation of the phases and the return of the epichlorohydrin phase takes place in a manner analogous that of Example 1. The remaining water is finally removed azeotropically within a period of 3 hours at 80° C. and under a pressure of 200 mbar.

After all the water has been distilled out of the reaction mix the contents of the reactor is cooled to ensure that the inorganic salts crystallise out completely. In contrast to Example 1, the stirrer is not shut down during the whole of the crystallisation time and the complete contents of the reactor are transferred to a closed filter dryer (Rosenmund filter with a surface of about 0.7 m² made by the Rosenmund Co. VAT AG, CH-4410, Liestal) and subjected to pressure under nitrogen. The filter cake is then loosened once and washed with portions of epichlorohydrin totalling 10 kg. Finally, the filter cake is dried with agitation in heated nitrogen. The epichlorohydrin mother-liquor and the epichlorohydrin washings are added together and processed as in Example 1.

The yield of epoxidised polysulphide is 97.5%.

1-13. (canceled)

14. A method for the production of polymeric polysulphides having epoxy terminal-groups in which polymeric polysulphides having thiol terminal-groups are dissolved in an excess of epichlorohydrin, the reaction being started by the addition of alkaline lye with more alkaline lye being added in a second stage whereby the water present in the reaction mixture is distilled azeotropically with epichlorohydrin after which the epichlorohydrin phase obtained in this manner is separated from the deposited salts and the epichlorohydrin is removed from the separated solution by distillation, whereby polymeric polysulphide having epoxy terminal-groups is left behind as a residue.

15. The method of claim 14, characterized in that the temperature in the first stage is maintained below 70° C. by cooling and in the second stage the temperature is maintained between 40 and 90° C. by heating.

16. The method of claim 15, characterized in that the temperature in the first stage is maintained in the range between 20 and 50° C.

17. The method of claim 14, characterized in that aqueous sodium lye is used as the alkaline lye.

18. The method of claim 17, wherein the alkaline lye is a 5 to 50% by weight solution of aqueous sodium lye.

19. The method of claim 14, characterized in that the alkaline lye is used in stoichiometric quantities or in excess.

20. The method of claim 19, characterized in that the alkaline lye is used in at least double the stoichiometric amount.

21. The method of claim 14, characterized in that during the first stage catalytic quantities or up to 20% of the total amount are added.

22. The method of claim 14, characterized in that a 2- to 12-fold excess of epichlorohydrin is used.

23. The method of claim 22, characterized in that a 3- to 10-fold excess of epichlorohydrin is used.

24. The method of claim 23, characterized in that a 4- to 8-fold excess of epichlorohydrin is used.

25. The method of claim 14, characterized in that the reaction is carried out in the presence of a phase transfer catalyst.

26. The method of claim 25, characterized in that the phase transfer catalyst is a quaternary ammonium salt.

27. The method of claim 26, characterized in that the quaternary ammonium salt is methyltrioctylammoniumchloride.

28. The method of claim 14, characterized in that after the azeotropic distillation of the water present in the reaction mixture, the alkali chloride which comes out of solution is filtered off in a closed filter, the alkali chloride then being washed with epichlorohydrin and that finally the epichlorohydrin still adhering to the alkali chloride is dried out by means of a heated inert gas.

29. The method of claim 14, characterized in that the virtually water-free organic phase is separated by decantation or by lifting out the eliminated salts.

30. The method of claim 14, characterized in that the obtained polymeric polysulphide is purified by further distillation treatment.

31. The method of claim 30, characterized in that the polymeric polysulphide having epoxy terminal-groups is purified by carrying out thin-layer distillation.

32. The method of claim 32, characterized in that the thin-layer distillation is carried out with the addition of an agent which forms an azeotrope with epichlorhydrin.

33. The method of claim 32, characterized in that the agent is n-propanol or iso-propanol.
